(19) United States
(12) Patent Application Publication
(10) Pub. No.: US 2016/0053729 A1
(43) Pub. Date: Feb. 25, 2016

(54) DUAL FUEL SYSTEMS AND METHODS WITH ADVANCED EXHAUST GAS RECIRCULATION

(71) Applicant: Cummins Inc., Columbus, IN (US)

(72) Inventors: Samuel C. Geckler, Columbus, IN (US); Anthony Kyle Perfetto, Columbus, IN (US)

(21) Appl. No.: 14/467,714

(22) Filed: Aug. 25, 2014

(51) Int. Cl. F02M 43/04; F02M 25/07

(52) U.S. Cl. CPC F02M 43/04; F02M 25/0706

(57) ABSTRACT

Systems and methods for fuelling a plurality of cylinders of an internal combustion engine are disclosed. The system includes an exhaust gas recirculation system for recirculating exhaust gas flow from at least one primary EGR cylinder of an engine into an intake system prior to combustion. The system further includes a fueling system to provide a first flow of a first fuel to each of the plurality of cylinders and a second flow of a second fuel to each of the primary EGR cylinders that is in addition to the first flow of the first fuel.

### FIELD OF THE INVENTION

The present invention relates generally to exhaust gas recirculation (EGR) in internal combustion engines, and more particularly is concerned with systems and methods for EGR from one or more primary EGR cylinders that are operable to receive dual fuel flows.

### BACKGROUND

Spark ignited engines exhibit abnormal combustion phenomena called “knock”, which occurs when combustion reactions in the unburned zone initiate rapid uncontrolled combustion prior to the arrival of the propagating flame front of a homogenous combustion process. One technique for limiting or controlling the combustion temperature of the engine has been to recirculate a portion of the exhaust gas back to the engine air intake to lower the oxygen content in the intake air. This reduces the combustion temperature of the intake charge. In order to recirculate exhaust gas, an EGR line that connects the exhaust manifold to the intake is provided.

A technique to increase the flame propagation rate to address knock is to have one or more cylinders dedicated to providing EGR flow to the engine intake. When the EGR line is connected with one or more cylinders dedicated to EGR, the engine acts as a positive displacement pump to drive the EGR flow, eliminating pumping losses in transporting exhaust to the intake system. Also, since the exhaust from the dedicated EGR cylinder does not escape the engine, it is possible to have alternative combustion processes and compression ratios with the dedicated cylinder(s). In addition, a variable geometry turbocharger is not required to drive EGR flow, facilitating meeting of target air-fuel ratios.

Engines operating with one or more cylinders as dedicated EGR cylinders enjoy greatly simplified controls and pressure management, fewer hardware devices, and other benefits. However, while there is some ability to control the combustion processes such as by running the dedicated EGR cylinder(s) to generate favorable species like hydrogen, the ability to do so is limited since the same fuel is used in the dedicated and non-dedicated cylinders. For example, certain fuels provide high energy density but do not readily produce favorable species such as hydrogen and carbon monoxide, which increase combustion speed, reduce engine knock, and improve fuel economy. Other fuels more readily produced favorable species, but sacrifice energy density and performance. Furthermore, in dual fuel systems without dedicated EGR, the substitution rate of the second fuel to produce favorable species is relatively high since only a portion of the exhaust gas produced by all the cylinders is involved in exhaust gas recirculation.

Thus, there remains a need for additional improvements in systems and methods with engines that include EGR flow to optimize operation, performance, and fuel economy.

### SUMMARY

Embodiments include unique systems and methods for an engine having a plurality of cylinders and an EGR system which receives exhaust gas flow primarily or entirely from a subset of the plurality of cylinders of the engine, also referred to as primary EGR cylinder(s). The exhaust gas recirculation system recirculates exhaust gas flow from at least one primary EGR cylinder of the engine into an air intake system. The systems and methods further include a fuel system that provides a first fuel flow from a first fuel source to the plurality of cylinders and a second fuel flow from a second fuel source to at least the primary EGR cylinder(s).

In some embodiments, the first fuel flow to the plurality of cylinders is controlled to provide an exhaust lambda value at a desired value from the non-primary EGR cylinders while the second fuel flow to the primary EGR cylinder(s) is controlled at engine loads below a low load threshold to provide an exhaust output from the primary EGR cylinders that reduces mis-fire and slow flame speeds.

In other embodiments, the second fuel flow to the primary EGR cylinders is provided at engine loads above a high load threshold to increase hydrogen generation from at least the primary EGR cylinders to provide a recirculated exhaust gas flow that reduces the propensity for knock at high engine loads. Additionally or alternatively, a second fuel flow to the non-primary EGR cylinders is also provided at engine loads above the high load threshold to utilize the fuel properties of the second fuel to reduce knock in addition to the EGR flow from the primary EGR cylinders.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 is a schematic illustration of an internal combustion engine system that is configured to provide EGR flow from one or more primary EGR cylinders and exhaust outlet flow from one or more non-primary EGR cylinders.

FIG. 2 is a schematic illustration of a portion of the internal combustion engine system of FIG. 1 showing one embodiment of a fueling system for the primary and non-primary EGR cylinders.

FIG. 3 is a schematic illustration of a portion of the internal combustion engine system of FIG. 1 showing another embodiment of a fueling system for the primary and non-primary EGR cylinders.

FIG. 4 is a flow diagram of a procedure for fueling the plurality of cylinders of the systems of FIGS. 1-3.

FIGS. 5A-5C are graphs showing a substitution of a secondary fuel for a primary fuel in response to engine load conditions.

### DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

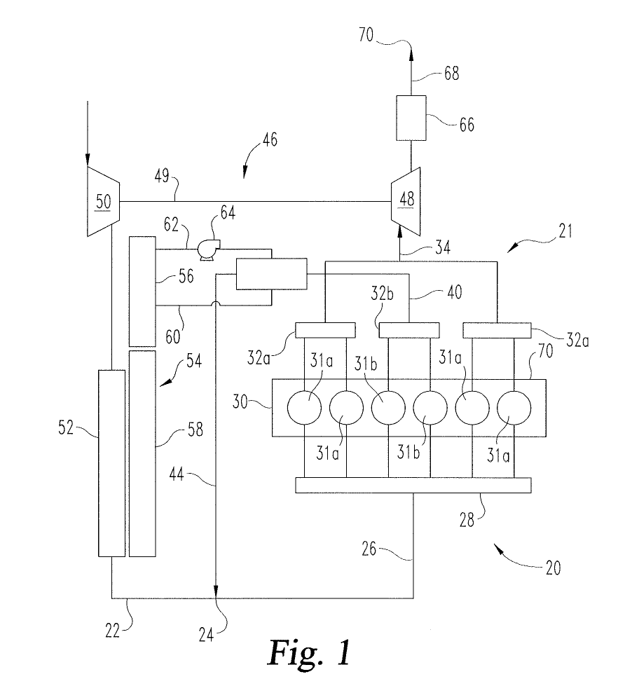

With reference to FIG. 1, a system 20 for providing an EGR flow from one or more primary EGR cylinders is illustrated in schematic form. System 20 may be provided with a vehicle, a stationary application, or any application which includes an internal combustion engine with EGR. System 20 is depicted having an engine 30 with an intake and exhaust system connected by an EGR system or loop 21. The engine 30 is an internal combustion engine of any type, and can include a stoichiometric engine or lean burn gasoline engine that is connected to two sources of fuel. In certain embodiments, the dual fuel engine 30 may be any engine type producing emissions that may be used in an EGR system to, for example to reduce knock and NO emissions from the engine 30. In the illustrated embodiment, the engine 30 includes six cylinders 31a-31b (collectively referred to as cylinders 31) in an in-line arrangement. However, the number of cylinders may be any number, and the arrangement of cylinders may be any arrangement, and is not limited to the number and arrangement shown in FIG. 1.

The engine 30 includes at least one primary EGR cylinder 31b in which the entire exhaust output is provided as EGR flow at least during certain operating conditions, and the remaining or non-primary EGR cylinders 31a do not provide EGR flow at least during certain operating conditions. While two primary EGR cylinders 31b are shown in FIG. 1, one primary EGR cylinder or three or more primary EGR cylinders are also contemplated. The term primary EGR, as utilized herein, should be read broadly. Any EGR arrangement wherein, during at least certain operating conditions, the entire exhaust output of certain primary EGR cylinder(s) 31b is recirculated to the engine intake is contemplated. In the system 20, the exhaust gas from the primary EGR cylinder(s) 31b recirculates and combines with intake gases at a position upstream of an intake manifold 28 of engine 30. The recirculated exhaust gas may combine with the intake gases at a mixer (not shown) at mixing location 24 of intake 22 or by any other arrangement. In certain embodiments, the recirculated exhaust gas returns to the intake manifold 28 directly. The EGR system 21 of FIG. 1 may be a high-pressure loop or system, for example, by returning the exhaust of the primary EGR cylinder(s) 31b to the intake 22 at a position downstream of a compressor 50 as shown, or a low-pressure loop, for example, by returning to the intake 22 at a position upstream of compressor 50.

Engine 30 includes an engine block 70 that at least partially defines the cylinders 31. A piston (not shown) may be slidably disposed within each cylinder 31 to reciprocate between a top-dead-center position and a bottom-dead-center position, and a cylinder head (not shown) may be associated with each cylinder 31. Each of the cylinders 31, its respective piston, and the cylinder head form a combustion chamber. In the illustrated embodiment, engine 30 includes six such combustion chambers. However, it is contemplated that engine 30 may include a greater or lesser number of cylinders and combustion chambers and that cylinders and combustion chambers may be disposed in an “in-line” configuration, a “V” configuration, or in any other suitable configuration.

System 20 also includes an intake 22 that may include one or more inlet supply conduits 23, a mixing location 24, an intake manifold supply conduit 26, and an engine intake manifold 28 connected to engine 30. System 20 also includes an exhaust system coupled to engine 30 that includes an engine exhaust manifold portion 32a connected to cylinders 31a and an exhaust manifold portion 32b connected to primary EGR cylinders 31a. Exhaust manifold portion 32b is connected to EGR conduit 40 of EGR system 21 and may be flow isolated from exhaust manifold portions 32a. Exhaust manifold portions 32a may be separate manifold portion or combined as a single manifold portion, and are connected to an exhaust conduit 34 which is connected to a turbocharger 46. The exhaust system further includes an aftertreatment system 66 downstream of turbocharger 46 connected with an outlet conduit 68. Aftertreatment system 66 includes, for example, a three-way catalyst for removing one or more pollutants from the exhaust gas stream and provides an exhaust flow through outlet conduit 68 to an exhaust outlet 70.

In one embodiment, engine 30 is a four stroke engine. That is, for each complete engine cycle (i.e., for every two full crankshaft rotations), each piston of each cylinder 31 moves through an intake stroke, a compression stroke, a combustion or power stroke, and an exhaust stroke. Thus, during each complete cycle for the depicted six cylinder engine, there are six strokes during which air is drawn into individual combustion chambers from intake manifold supply conduit 26. In the illustrated embodiment, during four strokes exhaust is expelled from individual cylinders 31a to exhaust conduit 34, and during two exhaust stroke exhaust gas is expelled from primary EGR cylinders 31b to recirculating exhaust gas supply conduit 40 to provide an EGR fraction of about 33%. These strokes correspond with pulsations of air and exhaust within the respective systems. It should be understood that other EGR fractions are contemplated. For example, by way of illustration and not limitation, an arrangement with one primary EGR cylinder 31b provides an EGR fraction of about 16%, and a four cylinder engine with a single primary EGR cylinder provides an EGR fraction of 25%.

EGR system 21 includes a recirculating exhaust gas supply conduit 40 that is separate from exhaust flow conduit 34. Supply conduit 40 extends from and is in flow communication with the combustion chamber(s) of the primary EGR cylinder(s) 31b of engine 30 that supplies exhaust gas flow to supply conduit 40. The EGR system 21 may also include an EGR cooler 38. EGR flow in EGR system 21 continues from EGR cooler 38 through an EGR conduit 44 to mixing location 24 where EGR flow is mixed with inlet flow from inlet supply conduit 23. EGR conduit 44 is flow coupled to mixing location 24 and the inlet supply conduit 23 is flow coupled to mixing location 24 to create a charge flow that includes combined inlet flow and recirculated exhaust gas from EGR system 21. The charge flow created at mixing location 24 is flow coupled to engine intake manifold 28 through intake manifold supply conduit 26.

The primary EGR cylinder(s) 31b of engine 30 is flow coupled to EGR cooler 38 through recirculating exhaust gas supply conduit 40, and EGR cooler 38 is flow coupled to mixing location 24 through EGR conduit 44. EGR cooler 38 may further be connected to a radiator system 54 including a low temperature radiator 56 and a high temperature radiator 58. A coolant return line 60 extends from EGR cooler 38 to radiator system 54 and a coolant supply line 62 supplies coolant from radiator system 54 to EGR cooler 38. Coolant supply line 62 may include a pump 64 to provide circulation of coolant flow. In another embodiment, the coolant system may utilize only one radiator, such as radiator 58. In still other embodiments, EGR system 21 includes a bypass and a control valve to selectively bypass all or a portion of the EGR flow around EGR cooler 38. In one embodiment, exhaust conduit 34 is flowed coupled to exhaust manifold portions 32a, and may also include one or more intermediate flow passages, conduits or other structures. Exhaust conduit 34 extends to a turbine 48 of turbocharger 46. Turbocharger 46 may be any suitable turbocharger known in the art, including variable-geometry turbine turbochargers and waste-gated turbochargers. Turbocharger 46 may also include multiple turbochargers. Turbine 48 is connected via a shaft 49 to a compressor 50 flow coupled to inlet supply conduit 23. Inlet supply conduit 32 may include a charge air cooler 52 downstream from compressor 50 and upstream from mixing location 24. In another embodiment, a charge air cooler 52 is located in the intake system downstream from mixing location 24.

In operation of system 20, fresh air is supplied through inlet air supply conduit 23. The fresh air flow or combined flows can be filtered, unfiltered, and/or conditioned in any known manner, either before or after mixing with the EGR flow from EGR system 21. The intake system may include components configured to facilitate or control introduction of the combined flow to engine 30, and may include an induction valve or throttle (not shown), one or more compressors 50, and charge air cooler 52. The induction valve may be connected upstream or downstream of compressor 50 via a fluid passage and configured to regulate a flow of atmospheric air and/or combined flow to engine 30. Compressor 50 may be a fixed or variable geometry compressor configured to receive air or combined flow from the induction valve and compress the air or combined flow to a predetermined pressure level before engine 30. Charge air cooler 52 may be disposed within inlet air supply conduit 23 between engine 30 and compressor 50, and embody, for example, an air-to-air heat exchanger, an air-to-liquid heat exchanger, or a combination of both to facilitate the transfer of thermal energy to or from the flow directed to engine 30.

In one embodiment, ambient air and/or combined flow is pressurized with compressor 50 and sent through charge air cooler 52 before delivery to mixing location 24. The EGR flow from EGR system 21 is distributed and mixed with inlet air at mixing location 24. The air-exhaust gas mixture is then supplied to engine 30 through intake manifold supply conduit 26 to engine intake manifold 28.

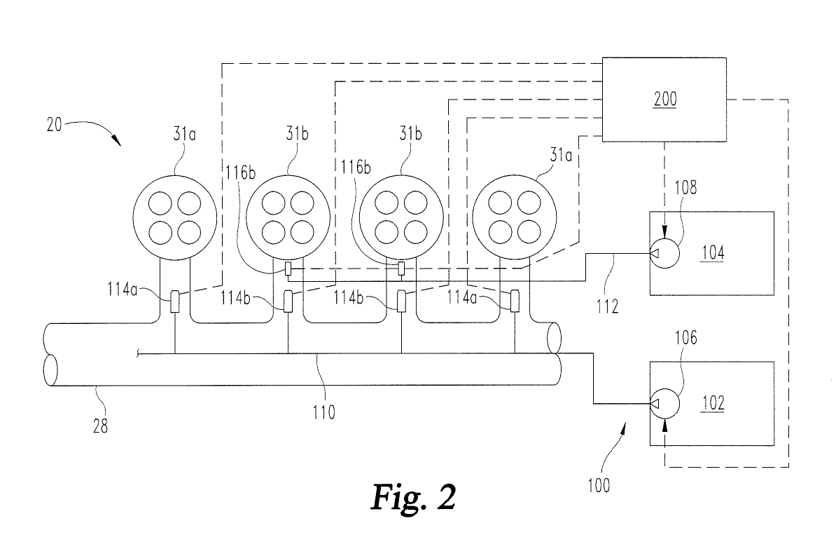

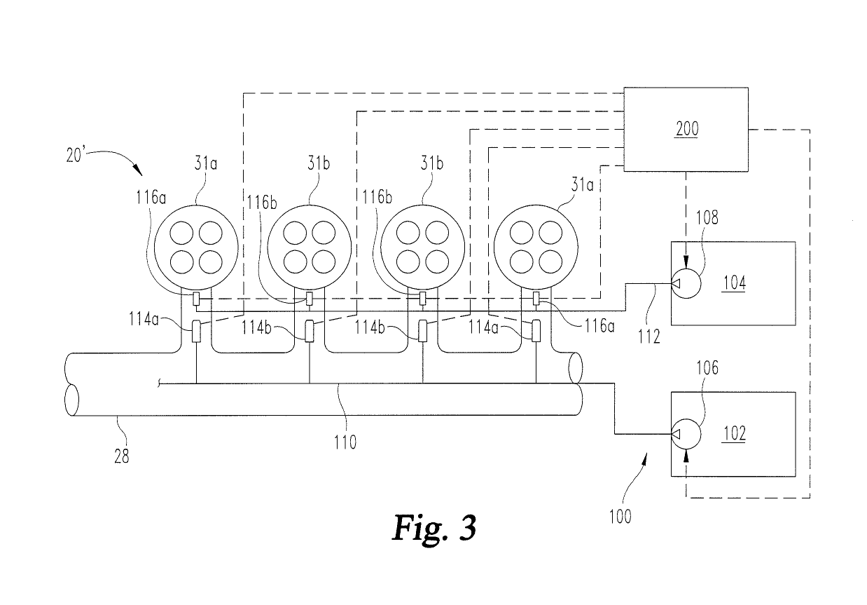

In certain embodiments, and as discussed further below with respect to FIGS. 2-3, the primary EGR cylinder(s) 31b and non-primary EGR cylinders 31a include at least one port injector for delivering fuel to the combustion chamber thereof from a primary or first fuel source. In addition, primary EGR cylinder(s) 3 1b includes at least one second port that is a port injector for delivering fuel to its combustion chamber from a secondary or second fuel source. The fueling from the primary fuel source is controlled to provide an exhaust lambda value from the non-primary EGR cylinders 31a that is stoichiometric. A second fuel flow to the primary EGR cylinder(s) 31b from the secondary fuel source is controlled to substitute for a portion of the fuel flow from the primary source to provide an exhaust lambda value from the primary EGR cylinder(s) 31b that is less than stoichiometric, or to provide some other desired characteristic or species in the exhaust from the primary EGR cylinders 31b that results from combustion of the second fuel. For example, the exhaust output from the primary EGR cylinder(s) 31b can be controlled by the second fuel flow to produce hydrogen and carbon monoxide. When these constituents are present in EGR system 21, they are in turn provided to the intake of all cylinders 31 to increase the combustion speed and combustion stability of cylinders 31, and reduce the production of pollutants during the combustion process and/or to reduce knock.

A port injector, as utilized herein, includes any fuel injection device that injects fuel outside the engine cylinder in the intake manifold to form the air-fuel mixture. The port injector sprays the fuel towards the intake valve. During the intake stroke, the downwards moving piston draws in the air/fuel mixture past the open intake valve and into the combustion chamber. Each cylinder 31 may include one or more port injectors. The first port injector may be the primary fueling device for the cylinders 31, and the second port injector provides a flow of fuel to from the secondary fuel source to at least primary EGR cylinders 31b.

In certain embodiments, each cylinder 31 includes a port injector connected to a first fuel source that is capable of providing all of the designed primary fueling amount for the cylinders 31 at any operating condition. The primary EGR cylinder(s) 31b include at least one additional port fuel injector to provide secondary fueling from a second fuel source to the primary EGR cylinder(s) 31b so that the exhaust output from the primary EGR cylinder(s) 31b differs from the exhaust output of the cylinders 31a to achieve desired operational outcomes, such as improved efficiency, improved fuel economy, improved high load operation, and other outcomes. In other embodiments, each cylinder 31 also includes a second port injector connected to the second fuel source.

Exhaust gas from the non-primary EGR cylinders 31a passes into an exhaust conduit 34 and through turbine 48. Exhaust gas from turbine 48 is outlet through an aftertreatment system 66 to exhaust outlet 70 to the atmosphere. The exhaust system along outlet conduit 68 may include components configured to treat exhaust from engine 30 before release to the atmosphere. Specifically, the exhaust system may include, for example, oxidation devices, particulate removing devices (DPF, CDPF), constituent absorbers or reducers (SCR, AMOX, LNT), three-way catalysts for stoichiometric spark ignited engines, attenuation devices (mufflers), controllers, etc., if desired.

In operation, engine 30 produces an exhaust gas stream from non-primary EGR cylinders 31a into exhaust conduit 34, an exhaust stream from primary EGR cylinder(s) 31b into EGR system 21, and receives a charge flow from intake manifold supply conduit 26 comprising intake air and recirculated exhaust gas from EGR system 21. The engine 30 is fluidly coupled to intake manifold 28 and exhaust manifold 32, and the EGR stream passes from the one or more primary EGR cylinder(s) 31b through EGR supply conduit 40.

With further reference to FIG. 2, one embodiment of system 20 is shown with a fuel system 100 that includes a first fuel source 102 to provide a primary fuel flow to all the cylinders 31 and a second fuel source 104 to provide a second fuel flow to primary EGR cylinder(s) 31b that substitutes for a portion of the primary fuel flow in response to certain operating conditions. Only two of cylinders 31a are shown in FIGS. 2-3 for purposes of clarity, it being understood that any cylinder arrangement discussed herein is contemplated, including the arrangement of FIG. 1. In one embodiment, first fuel source 102 is a primary fuel source that provides a flow of fuel to each of the cylinders 31, and second fuel source 104 is a secondary fuel source that provides a second flow of fuel only to primary EGR cylinder(s) 31b. The second flow of fuel changes the characteristics of the exhaust output of the primary EGR cylinder(s) 31b to produce a desired operational outcome of cylinders 31 using the recirculated exhaust gas from EGR system 21 of FIG. 1.

First fuel source 102 includes a first fuel pump 106 that is connected to a controller 200, and the second fuel source 104 includes a second fuel pump 108 that is connected to controller 200. Each of the cylinders 31 includes a first port injector, such as port injectors 114a-114d associated with each of the illustrated cylinders 301 of FIG. 2. Port injectors 114a-114d are electrically connected with controller 200 to receive fueling commands that provide a fuel flow to the respective cylinder in accordance with a fuel command determined according to engine operating conditions and operator demand by reference to fueling maps, control algorithms, or other fueling rate/amount determination source stored in controller 200. First fuel pump 106 is connected to each of the port injectors 114a-114d with a first fuel line 110. First fuel pump 106 is operable to provide a first fuel flow from first fuel source 102 to each of the cylinders 31 in an amount determined by controller 200 that achieves a desired power from cylinders 31 and desired exhaust output from the non-primary EGR cylinders 31a. Furthermore, primary EGR cylinders 31b include a second port injector 116a electrically connected with controller 200. Second fuel pump 108 is connected to each second port injector 116b with a second fuel line 112. Second fuel pump 108 is operable to provide a second fuel flow from second fuel source 104 in an amount determined by controller 200 that achieves a characteristic in the exhaust output from primary EGR cylinders 31b.

In one embodiment, the first fuel source 102 is gasoline and the second fuel source 104 is ethanol. Gasoline provides high energy density to achieve high performance and fuel economy when combusted by all the cylinders 31. The ethanol fuel provides a lower density fuel that can be substituted for a portion of the gasoline flow to primary EGR cylinders 31b to achieve an exhaust output that includes hydrogen and carbon monoxide which is re-circulated to each of the cylinders 31 by the EGR system 21. These species in the recirculated exhaust gas improves the combustion speed and reduces knock, while maintaining fuel economy and high load performance of the high energy density fuel and minimizing fuel economy impact from fueling with a lower energy density fuel.

In another embodiment of system 20 illustrated in FIG. 3, a system 20′ is shown in which like components with system 20 are designated with the same reference numerals used previously herein. In system 20′, non-primary EGR cylinders 31a also include a second injector in the form of a port injector 116a electrically connected with controller 200. Second fuel pump 108 is connected to port injectors 116a with second fuel line 112. Second fuel pump 108 is operable to provide a second fuel flow from second fuel source 104 through port injectors 116a, in addition to the first fuel flow from first fuel source 102 through port injector 114a, in an amount determined by controller 200 in response to certain operating conditions that achieves a desired power and exhaust output from non-primary EGR cylinders 31a.

In other embodiments, one or more of port injectors 114a, 114b, 116a, 116b can be replaced with a direct injector electrically connected with controller 200 and the corresponding fuel source 102, 104. The various embodiments disclosed herein contemplate various fuels for first fuel source 102 other than gasoline, including, but not limited to, a gasoline and ethanol alcohol mix such as E85, and natural gas. The second fuel source 104 can include fuels other than ethanol.

In certain embodiments of the systems disclosed herein, controller 200 is structured to perform certain operations to control engine operations and fueling of cylinders 31 with fueling system 100 to provide the desired exhaust output from the non-primary cylinders 31a and the primary EGR cylinder(s) 31b. In certain embodiments, the controller 200 forms a portion of a processing subsystem including one or more computing devices having memory, processing, and communication hardware. The controller 200 may be a single device or a distributed device, and the functions of the controller 200 may be performed by hardware or software. The controller 200 may be included within, partially included within, or completely separated from an engine controller (not shown). The controller 200 is in communication with any sensor or actuator throughout the systems disclosed herein, including through direct communication, communication over a datalink, and/or through communication with other controllers or portions of the processing subsystem that provide sensor and/or actuator information to the controller 200.

Certain operations described herein include operations to interpret or determine one or more parameters. Interpreting or determining, as utilized herein, includes receiving values by any method known in the art, including at least receiving values from a datalink or network communication, receiving an electronic signal (e.g. a voltage, frequency, current, or PWM signal) indicative of the value, receiving a software parameter indicative of the value, reading the value from a memory location on a non-transient computer readable storage medium, receiving the value as a run-time parameter by any means known in the art, and/or by receiving a value by which the interpreted parameter can be calculated, and/or by referencing a default value that is interpreted to be the parameter value.

The schematic flow description which follows provides an illustrative embodiment of performing procedures for providing compositional feedback control of an EGR system in combination with a dual fuel flow to at least the primary EGR cylinders 31b such as is provided with fuel system 100. As used herein, a dual fuel flow system is a fueling system in which each of the cylinders 31 receives a first fuel flow and at least the primary EGR cylinder(s) 31b receive a second fuel flow that substitutes for a portion of the first fuel flow in response to certain operating conditions. Operations illustrated are understood to be exemplary only, and operations may be combined or divided, and added or removed, as well as re-ordered in whole or part, unless stated explicitly to the contrary herein. Certain operations illustrated may be implemented by a computer executing a computer program product on a non-transient computer readable storage medium, where the computer program product comprises instructions causing the computer to execute one or more of the operations, or to issue commands to other devices to execute one or more of the operations.

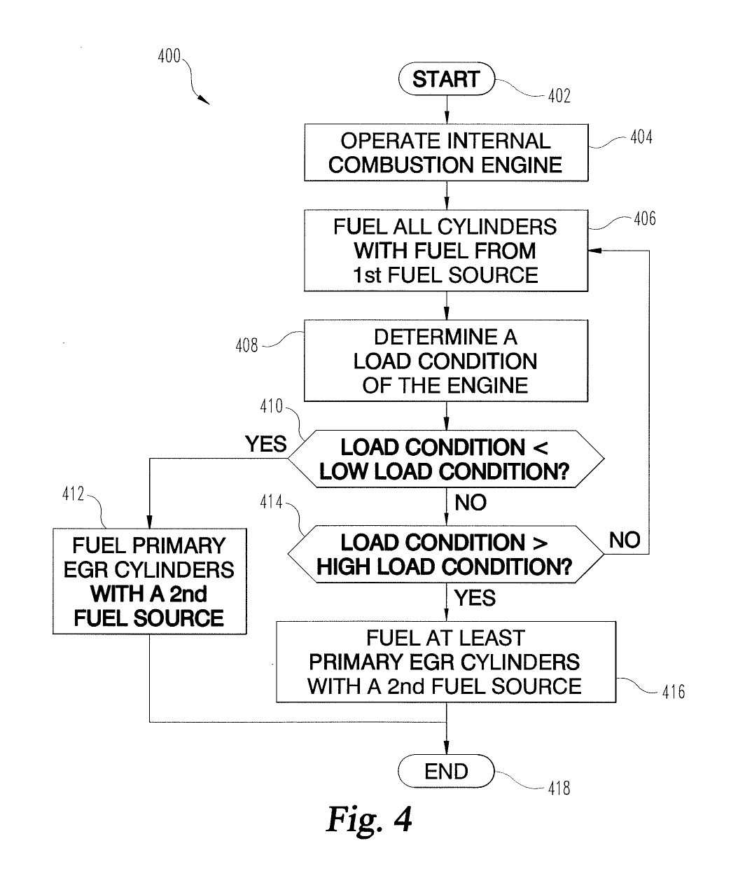

In FIG. 4, one embodiment of a flow diagram for operating engine 30 with EGR system 21 and a fueling system 100 is disclosed. Procedure 400 starts at 402 upon, for example, starting of engine 30. At operation 404, engine 30 is operated to produce an exhaust flow from cylinders 30 by combustion of fuel from at least first fuel source 102. For example, at operation 406, all cylinders 31 are fuelled with fuel from first fuel source 102 while operating engine 30. In another embodiment, all cylinders 31 are also fuelled with a second fuel from second fuel source 104 in addition to the first fuel. In a further embodiment, only primary EGR cylinders 31b are fuelled with a second fuel from second fuel source 104 in addition to the first fuel.

At operation 408, a load condition of engine 30 is determined. The load conditions can include, for example, a low engine load, a high engine load, or a load between a low engine load threshold and a high engine load threshold. The load condition of engine 30 can be determined by any suitable method, such as by determining the speed of engine 20 and fuel amount supplied to cylinders 31 and referring to a torque map. In addition, the load condition of engine 30 can be based at least in part on current or anticipated operating conditions such as, for example, fuel type, a cold start condition, a warm-up condition, or other condition in which fueling of cylinders 301 may be controlled to provide a desired operational outcome, such as increasing an aftertreatment system temperature, mitigating emissions of pollutants, reduction of knock, or meeting certain performance requirements over a period of time. In one embodiment, a fueling rate to each of the cylinders 31 from the first fuel source 102 is determined to obtain a stoichiometric lambda value in the exhaust output from the non-primary EGR cylinders 31a. A stoichiometric lambda value represents the ideal stoichiometric ratio of air to fuel in the intake charge flow to the cylinders 31 to completely burn the fuel. Any stoichiometric value understood in the art is contemplated depending on fuel properties, operating conditions, and other factors understood by those of ordinary skill in the art. In one embodiment, the stoichiometric lambda value ranges from 0.75 to 1.1. In another embodiment, the stoichiometric lambda value ranges from 0.85 to 1.05. In yet another embodiment, the stoichiometric lambda value ranges from 0.9 to 1.0. In addition, obtaining or operating at a stoichiometric value can be an operating mode and can include an operating condition slightly rich or slight lean of stoichiometric.

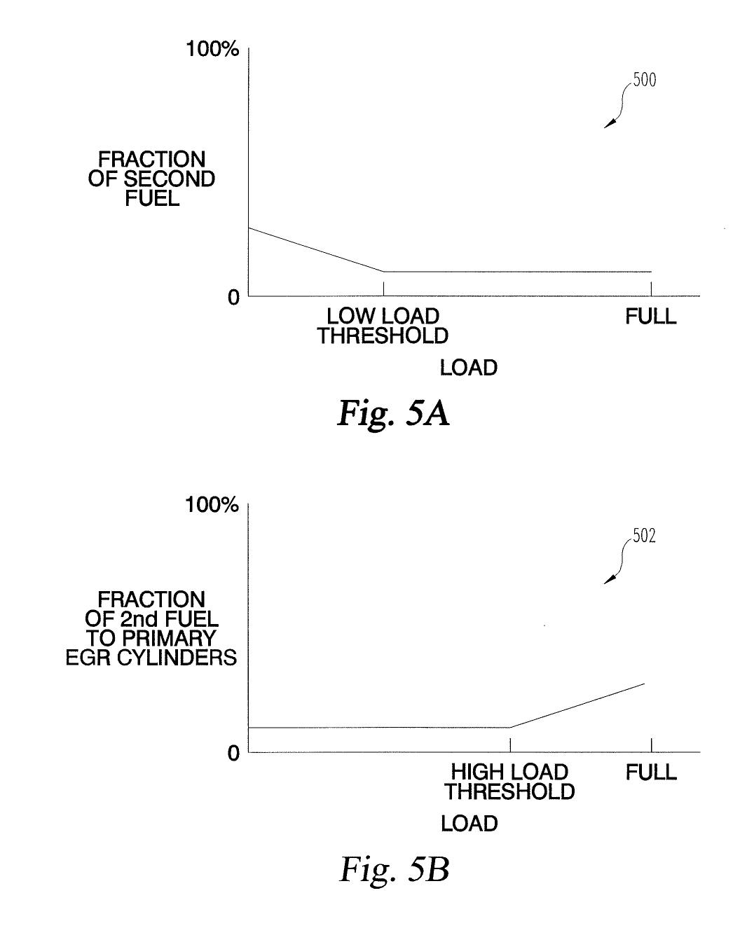

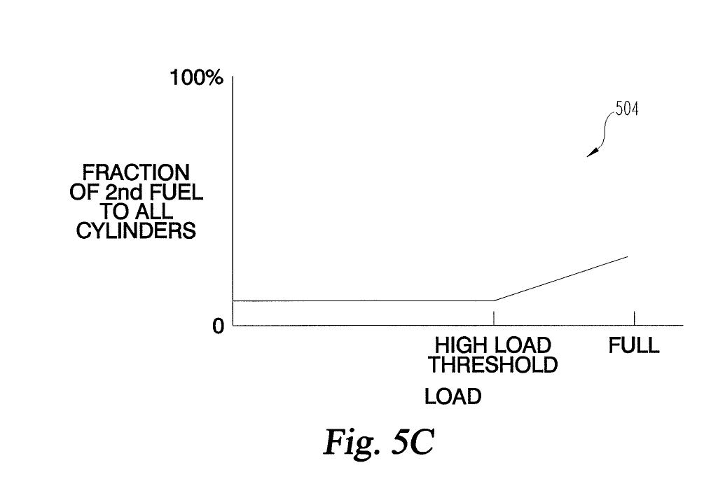

These operating conditions are used at conditional 410 to determine if the load condition of engine 30 is less than a low load condition. A low load condition can be defined by any suitable means, such as a load condition that is less than a threshold percentage of a full load condition, less than a threshold torque value, or less than any suitable threshold value that is predetermined or varies in response to current and/or anticipated operating conditions. If conditional 410 is satisfied, the procedure 400 continues at operation 412 to fuel the primary EGR cylinders 31b with a fuel flow from the second fuel source 104 that substitutes for a portion of the fuel flow from the first fuel source 102 to, for example, increase a hydrogen content in the exhaust output from primary EGR cylinders 31b. As shown graph 500 of FIG. 5A, the fuelling amount from the second fuel source can vary directly with the amount by which the engine load is less than the low load threshold.

In certain embodiments, the second fuel is a fuel that has a higher hydrogen to carbon ratio than the primary fuel, such as ethanol when the primary fuel is gasoline. Increasing the hydrogen content of the EGR flow inversely to the load condition of engine 30 increases the tolerance of the cylinders 31 to the high EGR fraction provided by EGR system 21 at low load conditions by improving combustion stabilities and flame speed. In one embodiment, when the load condition of engine 30 is greater than the low load threshold, the fuelling amount is supplied entirely by first fuel source 102.

If conditional 410 is negative, procedure 400 continues at conditional 414 to determine if the load condition of engine 30 is greater than a high load condition. A high load condition can be defined by any suitable means, such as a load condition that is more than a threshold percentage of a full load condition, more than a threshold torque value, or more than any suitable threshold value that is predetermined or varies in response to current operating conditions. If conditional 414 is satisfied, the procedure 400 continues at operation 416 to fuel the primary EGR cylinders 31b with a fuel flow from the second fuel source 104 that substitutes for a portion of the fuel flow from the first fuel source 102 to, for example, increase a hydrogen content in the exhaust output from primary EGR cylinders 31b and reduce or mitigate knock in cylinders 31. As shown graph 502 of FIG. 5B, the fuelling amount from the second fuel source can vary directly with the amount by which the engine load is more than the high load threshold. If conditional 414 is negative, or if one of operations 412, 416 are performed, procedure 400 returns to operation 406, or ends at 418 in response to a key-off, engine shut-down event, or other termination event.

In anther embodiment shown in graph 504 of FIG. 5C, fuel is provided to all cylinders 31 from the second fuel source 104 in response to the engine load condition being more than the high load threshold. In still another embodiment, fuelling is provided entirely from the first fuel source 102 if the load condition of engine 30 is between the low load condition and the high load condition, or between the low load threshold and the high load threshold. The second fuel from the second fuel source 104 can be provided in a second fuelling amount in which the lambda value for the primary EGR cylinder(s) 31b is set to be less than stoichiometric to provide a rich fueling condition to the primary EGR cylinder(s) 31b, which increases the beneficial presence of hydrogen and CO in the recirculated exhaust gas. The fueling of the plurality of cylinders 31 in response to the determined fuel amount includes, without limitation, fueling the cylinders with the fuel amount required to achieve a desired lambda value, progressing acceptably toward the fuel amount required to achieve the lambda value, and/or fueling with an amount otherwise limited such as by oxygen-fuel limits, torque production limits, engine vibration limits, intake manifold or EGR system temperature limits, knock reduction limits, etc. Example operations to interpret the lambda value include, without limitation, interpreting a lambda value in an exhaust stream of an internal combustion engine from the non-primary EGR cylinders 31a and from the primary EGR cylinder(s) 31b using any known method, sensor or combination of sensors in the exhaust for determining air to fuel ratio in the cylinders 31.

Various aspects of the systems and methods disclosed herein are contemplated. For example, one aspect relates to a method that includes operating an internal combustion engine. The engine includes a plurality of cylinders, an exhaust system, and an intake system. At least one of the plurality of cylinders is a primary EGR cylinder operably connected to provide exhaust flow to an EGR system and a remaining portion of the plurality of cylinders are operably connected to provide exhaust flow to the exhaust system. The system further includes a first fuel source that is connected to each of the plurality of cylinders and a second fuel source connected at least to the at least one primary EGR cylinder. The method also includes providing a first fuel flow only from the first fuel source to each of the plurality of cylinders in response to a first load condition of the internal combustion engine and, in response to a second load condition of the internal combustion engine that is one of a low load condition and a high load condition, providing a second fuel flow from the second fuel source to the at least one primary EGR cylinder while providing the first fuel flow to each of the plurality of cylinders. The first load condition is between the low load condition and the high load condition.

In one embodiment, the first fuel source includes gasoline and the second fuel source includes ethanol. In another embodiment, the fuel of the first fuel source and the fuel of the second fuel source are different fuels. In another embodiment, the first fuel flow is provided to each of the plurality of cylinders through a plurality of first fuel injectors associated with respective ones of the plurality of cylinders, and the second fuel flow is provided to the at least one primary EGR cylinder through a second fuel injector associated with the at least one primary EGR cylinder. In a refinement of this embodiment, the first fuel injectors and the second fuel injector are port fuel injectors.

In another embodiment, he plurality of cylinders are operated to combust the first fuel flow to obtain an exhaust output having a first stoichiometric lambda value from the remaining portion of the plurality of cylinders and each primary EGR cylinder is operated to combust the first fuel flow and the second fuel flow to obtain an exhaust output having a second lambda value that is less than the first lambda value. In a further embodiment, the second fuel flow is controlled as a function of knock in each of the plurality of cylinders.

In a further embodiment, the second fuel flow is provided in response to the second load condition being greater than a first threshold associated with the high load condition. In a refinement of this embodiment, an amount of the second fuel flow is directly proportional to an amount the second load condition exceeds the first threshold. In another refinement, the second fuel source is connected with each of the plurality of cylinders and providing the second fuel flow includes providing the second fuel flow to each of the plurality of cylinders. In yet another refinement, the second fuel flow is provided in response to the second load condition being less than a second threshold associated with the low load condition, wherein the second threshold is less than the first threshold. In a further refinement, an amount of the second fuel flow is directly proportional to an amount the second load condition is less than the second threshold.

According to another embodiment, the second fuel flow is provided in response to the first load condition being less than a threshold associated with the low load condition. In a refinement of this embodiment, an amount of the second fuel flow is directly proportional to an amount the second load condition is less than the threshold. In a further refinement, the second fuel flow is provided only to the at least one primary EGR cylinder.

According to another aspect, a method includes producing a flow of exhaust from a plurality of cylinders of an internal combustion engine into an exhaust system of the internal combustion engine; directing the flow of exhaust created by combustion in a portion of the plurality of cylinders that are primary EGR cylinders to an EGR system to mix with an intake flow to the plurality of cylinders for combustion by the plurality of cylinders; and directing the flow of exhaust created by combustion in a remaining portion of the plurality of cylinders to an exhaust outlet, where the remaining portion of the plurality of cylinders do not include the primary EGR cylinders. The method further includes determining a load condition of the internal combustion engine and providing a first flow of fuel from a first fuel source to each of the plurality of cylinders in conjunction with providing a second flow of fuel from a second fuel source connected to each of the primary EGR cylinders in response to the load condition of the internal combustion engine being one of less than a low load threshold and greater than a high load threshold.

In one embodiment, wherein the second fuel source is connected only to the primary EGR cylinders. In another embodiment, the second fuel source is connected to each of the plurality of cylinders. In a refinement of this embodiment, in response to the load condition of the internal combustion engine being less than the low load threshold, the method include providing the second flow of fuel from the second fuel source only to the primary EGR cylinders. In yet a further refinement, in response to the load condition of the internal combustion engine being greater than the high load threshold, the method includes providing the second flow of fuel from the second fuel source to each of the plurality of cylinders.

In another embodiment, each of the plurality of cylinders includes a first port injector connected to the first fuel source and the primary EGR cylinders include a second port injector connected to the second fuel source. In a further embodiment, each of the plurality of cylinders includes a first port injector connected to the first fuel source and a second port injector connected to the second fuel source. In yet another embodiment, the first fuel source includes gasoline and the second fuel source includes ethanol.

According to another aspect, a system includes an engine including a plurality of cylinders, an intake system configured to direct a charge flow to all of the plurality of cylinders, an exhaust system configured to receive exhaust from a first portion of the plurality of cylinders and outlet the exhaust to atmosphere, and an EGR system configured to receive exhaust from only a second portion of the plurality of cylinders and direct the exhaust from the second portion of the plurality of cylinders to the intake system. The system further includes a fuel system including a first fuel source that is connected to each of the plurality of cylinders and a second fuel source that is connected to the second portion of the plurality of cylinders. A controller is connected to the engine and the fuel system, and the controller is configured to determine a load condition of the engine and, in response to the load condition being one of greater than a high load threshold and less than a low load threshold, provide a first fuel flow from the first fuel source to each of the plurality of cylinders while providing a second fuel flow from the second fuel source to at least the second portion of the plurality of cylinders.

In one embodiment, the second portion of the plurality of cylinders is dedicated entirely to providing exhaust for recirculation to the intake system. In another embodiment, the system includes a turbocharger system including a turbine connected to the first portion of the plurality of cylinders to receive exhaust therefrom. In another embodiment, the second fuel source is connected to only to the second portion of the plurality of cylinders.

In another embodiment, the second fuel source is connected to each of the plurality of cylinders, and the controller is configured to provide the second fuel flow to each of the plurality of cylinders in response to the load condition being greater than the high load threshold and only to the second portion of the plurality of cylinders in response to the load condition being less than the low load threshold. In yet another embodiment, each of the plurality of cylinders includes a port injector connected to the first fuel source and each of the second portion of the plurality of cylinders further includes a second port injector connected to the second fuel source. In another embodiment, each of the plurality cylinders includes a first port injector connected to the first fuel source and a second port injector connected to the second fuel source. In still another embodiment, the first fuel source includes gasoline and the second fuel source includes ethanol.

While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention. Accordingly, all such modifications are intended to be included within the scope of this disclosure as defined in the following claims.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method, comprising:
operating an internal combustion engine including a plurality of cylinders, an exhaust system, and an intake system, at least one of the plurality of cylinders being a primary exhaust gas recirculation (EGR) cylinder operably connected to provide exhaust flow to an exhaust gas recirculation (EGR) system and a remaining portion of the plurality of cylinders being operably connected to provide exhaust flow to the exhaust system, and further comprising a first fuel source that is connected to each of the plurality of cylinders and a second fuel source connected at least to the at least one primary EGR cylinder;
providing a first fuel flow only from the first fuel source to each of the plurality of cylinders in response to a first load condition of the internal combustion engine; and
in response to a second load condition of the internal combustion engine that is one of a low load condition and a high load condition, providing a second fuel flow from the second fuel source to the at least one primary EGR cylinder while providing the first fuel flow to each of the plurality of cylinders, wherein the first load condition is between the low load condition and the high load condition.

2. The method of claim 1, wherein the first fuel source includes gasoline and the second fuel source includes ethanol.

3. The method of claim 1, wherein the first fuel flow is provided to each of the plurality of cylinders through a plurality of first fuel injectors associated with respective ones of the plurality of cylinders, and the second fuel flow is provided to the at least one primary EGR cylinder through a second fuel injector associated with the at least one primary EGR cylinder.

4. The method of claim 3, wherein the first fuel injectors and the second fuel injector are port fuel injectors.

5. The method of claim 1, wherein the plurality of cylinders are operated to combust the first fuel flow to obtain an exhaust output having a first stoichiometric lambda value from the remaining portion of the plurality of cylinders and each primary EGR cylinder is operated to combust the first fuel flow and the second fuel flow to obtain an exhaust output having a second lambda value that is less than the first lambda value.

6. The method of claim 1, wherein the second fuel flow is controlled as a function of knock in each of the plurality of cylinders.

7. The method of claim 1, wherein the second fuel flow is provided in response to the second load condition being greater than a first threshold associated with the high load condition.

8. The method of claim 7, wherein an amount of the second fuel flow is directly proportional to an amount the second load condition exceeds the first threshold.

9. The method of claim 7, wherein the second fuel source is connected with each of the plurality of cylinders and providing the second fuel flow includes providing the second fuel flow to each of the plurality of cylinders.

10. The method of claim 7, wherein the second fuel flow is provided in response to the second load condition being less than a second threshold associated with the low load condition, wherein the second threshold is less than the first threshold.

11. The method of claim 10, wherein an amount of the second fuel flow is directly proportional to an amount the second load condition is less than the second threshold.

12. The method of claim 1, wherein the second fuel flow is provided in response to the first load condition being less than a threshold associated with the low load condition.

13. The method of claim 12, wherein an amount of the second fuel flow is directly proportional to an amount the second load condition is less than the threshold.

14. The method of claim 13, wherein the second fuel flow is provided only to the at least one primary EGR cylinder.

15. The method of claim 1, wherein the fuel of the first fuel source and the fuel of the second fuel source are different fuels.

16. A method, comprising:
producing a flow of exhaust from a plurality of cylinders of an internal combustion engine into an exhaust system of the internal combustion engine;
directing the flow of exhaust created by combustion in a portion of the plurality of cylinders that are primary exhaust gas recirculation (EGR) cylinders to an exhaust gas recirculation system to mix with an intake flow to the plurality of cylinders for combustion by the plurality of cylinders;
directing the flow of exhaust created by combustion in a remaining portion of the plurality of cylinders to an exhaust outlet, wherein the remaining portion of the plurality of cylinders do not include the primary EGR cylinders;
determining a load condition of the internal combustion engine; and
providing a first flow of fuel from a first fuel source to each of the plurality of cylinders in conjunction with providing a second flow of fuel from a second fuel source connected to each of the primary EGR cylinders in response to the load condition of the internal combustion engine being one of less than a low load threshold and greater than a high load threshold.

17. The method of claim 16, wherein the second fuel source is connected only to the primary EGR cylinders.

18. The method of claim 16, wherein the second fuel source is connected to each of the plurality of cylinders.

19. The method of claim 18, wherein in response to the load condition of the internal combustion engine being less than the low load threshold, providing the second flow of fuel from the second fuel source only to the primary EGR cylinders.

20. The method of claim 19, wherein in response to the load condition of the internal combustion engine being greater than the high load threshold, providing the second flow of fuel from the second fuel source to each of the plurality of cylinders.

21. The method of claim 16, wherein each of the plurality of cylinders includes a first port injector connected to the first fuel source and the primary EGR cylinders include a second port injector connected to the second fuel source.

22. The method of claim 16, wherein each of the plurality of cylinders includes a first port injector connected to the first fuel source and a second port injector connected to the second fuel source.

23. The method of claim 16, wherein the first fuel source includes gasoline and the second fuel source includes ethanol.

24. A system, comprising:
an engine including a plurality of cylinders;
an intake system configured to direct a charge flow to all of the plurality of cylinders;
an exhaust system configured to receive exhaust from a first portion of the plurality of cylinders and outlet the exhaust to atmosphere;
an exhaust gas recirculation system configured to receive exhaust from only a second portion of the plurality of cylinders and direct the exhaust from the second portion of the plurality of cylinders to the intake system;
a fuel system including a first fuel source that is connected to each of the plurality of cylinders, a second fuel source that is connected to the second portion of the plurality of cylinders; and
a controller connected to the engine and the fuel system, wherein the controller is configured to determine a load condition of the engine and in response to the load condition being one of greater than a high load threshold and less than a low load threshold, provide a first fuel flow from the first fuel source to each of the plurality of cylinders while providing a second fuel flow from the second fuel source to at least the second portion of the plurality of cylinders.

25. The system of claim 24, wherein the second portion of the plurality of cylinders is dedicated entirely to providing exhaust for recirculation to the intake system.

26. The system of claim 24, further comprising a turbocharger system including a turbine connected to the first portion of the plurality of cylinders to receive exhaust therefrom.

27. The system of claim 24, wherein the second fuel source is connected to only to the second portion of the plurality of cylinders.

28. The system of claim 24, wherein the second fuel source is connected to each of the plurality of cylinders, and the controller is configured to provide the second fuel flow to each of the plurality of cylinders in response to the load condition being greater than the high load threshold and only to the second portion of the plurality of cylinders in response to the load condition being less than the low load threshold.

29. The system of claim 24, wherein each of the plurality of cylinders includes a port injector connected to the first fuel source and each of the second portion of the plurality of cylinders further includes a second port injector connected to the second fuel source.

30. The system of claim 24, wherein each of the plurality cylinders includes a first port injector connected to the first fuel source and a second port injector connected to the second fuel source.

31. The system of claim 24, wherein the first fuel source includes gasoline and the second fuel source includes ethanol.
